(19) United States
(12) Patent Application Publication
(10) Pub. No.: US 2007/0095402 A1
(43) Pub. Date: May 3, 2007

(54) Pressure reducer

(75) Inventor: Willi Hecking, Niederkruechten-Elmpt (DE)

Correspondence Address: THORPE NORTH & WESTERN, LLP., 8180 SOUTH 700 EAST, SUITE 200, SANDY, UT, 84070, US

(73) Assignee: Hans Sasserath & Co. KG, Korschenbroich (DE)

(21) Appl. No.: 11/590,138

(22) Filed: Oct. 30, 2006

(30) Foreign Application Priority Data
Oct. 31, 2005 (DE) 10 2005 052 385.4

(51) Int. Cl. G05D 16/04

(52) U.S. Cl. 137/508

(57) ABSTRACT

A pressure reducer assembly (10) with an inlet (26) and an outlet (78) adapted to be connected through a valve, having a fixed valve disc (42) and a valve seat body (62) cooperating with the valve disc (42), the valve seat body adapted to be set by a lifting member, which is exposed to the outlet pressure in a closing direction against the bias of a helical spring (50), wherein the inlet and the space (68) upstream of the valve seat (74) are in fluid communication through an axial bore hole (36) in a valve spindle (34) which is connected to the valve disc (42), the valve seat body (62) is pot shaped and moveably guided on the valve spindle (34), the helical spring (50) surrounds the valve spindle (34) coaxially to the bore hole (36) and acts between a spring abutment (38) provided at the valve spindle (34) and the pot shaped valve seat body (62).

### TECHNICAL FIELD

The invention relates to pressure reducer assembly with an inlet and an outlet adapted to be connected through a valve, having a fixed valve disc and a valve seat body cooperating with the valve disc, the valve seat body adapted to be set by a lifting member, which is exposed to the outlet pressure in a closing direction against the bias of a helical spring.

### PRIOR ART

Pressure reducers are used to limit the outlet pressure of a liquid to a given pressure level. They comprise a valve which is controlled by a lifting member. The lifting member, usually a diaphragm, is exposed to the outlet pressure against the effect of a preload. The preload is normally a spring. If the outlet pressure increases the valve is further opened. Pressure reducers are normally integrated in a casing with an inlet and an outlet. The diaphragm serving as a lifting member is fixed in the casing.

In pressure reducers of the prior art, the valve disc of the valve is fixed with respect to the casing while the valve seat body, serving as a valve seat and at the same time as a lifting member, is movable relative to the fixed valve disc. Thereby a diaphragm likely to be damaged during long time operation can be avoided.

In a known pressure reducer assembly the outlet and the inlet are coaxially arranged in a pipe. The valve passage extends in a radial direction perpendicular to the axis of the inlet and the outlet. The helical spring serving as a preload is arranged in a projecting casing portion.

### DISCLOSURE OF THE INVENTION

It is an object of the invention to provide an assembly of the above mentioned kind which is particularly compact and simple. It is a further object of the invention to provide a pressure reducer assembly which can be integrated inside a pipe. Further objects of the invention will be described below.

As claimed in the invention, this object is achieved with a pressure reducer of the above mentioned kind, in that
(a) the inlet and the space upstream of the valve seat are in fluid communication through an axial bore hole in a valve spindle which is connected to the valve disc,
(b) the valve seat body is pot shaped and moveably guided on the valve spindle,
(c) the helical spring surrounds the valve spindle coaxially to the bore hole and acts between a spring abutment provided at the valve spindle and the pot shaped valve seat body.

In such an assembly the valve passage and the valve spindle extend coaxially between the inlet and the outlet. Thereby the pressure reducer can be integrated into the inside of a pipe without parts of the assembly projecting towards the outside. There is no need to make use of an expensive and sensitive diaphragm. The outer diameters can be kept small by using the inner space of the valve spindle as a passage. Only a valve seat body is required.

Preferably the entire assembly is adapted to be inserted in one piece into a tube shaped casing like a cartridge. Then the pressure reducer can be easily exchanged and/or serviced.

Preferably the spring abutment is pot-shaped and provided downstream with an annular groove wherein the helical spring is positioned. Thereby a particularly compact assembly is achieved.

A cylindrical dirt trap can be provided in the inlet.

The valve disc of a preferred embodiment of the invention is arranged at the outlet side end of the valve spindle and the bore hole in the valve spindle is connected to a hollow space upstream of the valve seat through a radially extending passage. The water flows, therefore, from the inlet through the valve spindle, through the radial passage into the hollow space before the valve seat. From there it reaches the outlet through the opened valve.

An embodiment is described below in greater detail with reference to the accompanying drawings. It will nevertheless be understood that no limitation of the scope of the invention is thereby intended. Alterations and further modifications of the inventive features illustrated herein, and additional applications of the principles of the inventions as illustrated herein, which would occur to one skilled in the relevant art and having possession of this disclosure, are to be considered within the scope of the invention.

### BRIEF DESCRIPTION OF THE DRAWINGS

FIG. 1 is a cross sectional view of a pressure reducer in an open position.

FIG. 2 is an enlarged view of the pressure reducer of FIG. 1 in a closed position.

FIG. 3 shows the pressure reducer of FIG. 2 in an open position

FIG. 4 shows the pressure reducer integrated into a pipe.

### DESCRIPTION OF THE EMBODIMENT

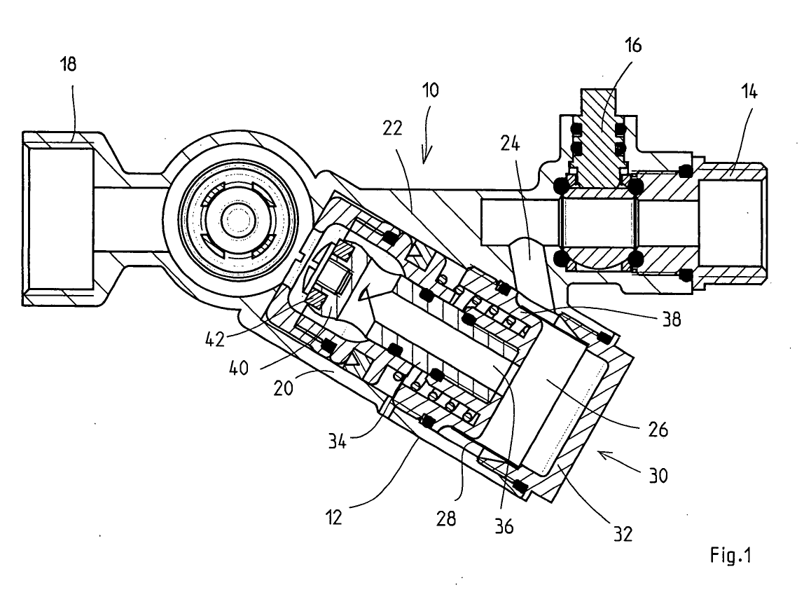

FIG. 1 shows a fitting 10 with a pressure reducer 12. The fitting 10 comprises an inlet 14 for connection to a drinking water supply (not shown). The inlet 14 is adapted to be shut off by a shut-off valve 16. The pressure reducer generally denoted with numeral 12 is provided between the shut-off valve 16 and an outlet 18. The pressure reducer 12 is arranged in a casing part 20 integrated in a fitting casing 22. In operation water flows from the inlet 14 through a passage 24 into an inlet chamber 26. The casing part 20 is tube-shaped, the center axis defining an angle with the center axis of the rest of the casing. A cylindrical dirt trap 28 is arranged in the inlet chamber 26 covering the inlet chamber 26 from the passage 24. At an end 30 the casing part 20 is provided with a removable lid 32. In such a way the inside of the tube shaped casing part 20 is accessible, for example, for servicing or for exchanging the pressure reducer.

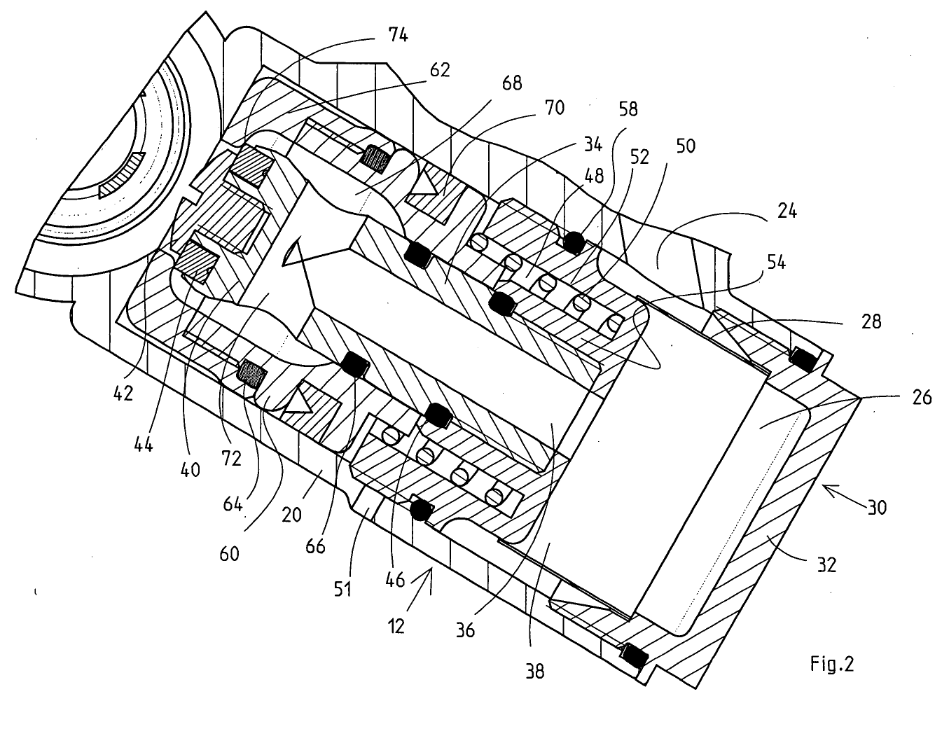

The pressure reducer comprises a casing fixed valve disc assembly and a movable valve seat body assembly (FIG. 2). The casing fixed valve disc assembly comprises a valve spindle 34. The valve spindle 34 is elongated and provided with an axial center bore hole 36. On the inlet side the center bore hole 36 ends in the inlet chamber 26.

On the inlet side a pot-shaped spring abutment 38 is provided coaxially around the valve spindle, the spring abutment being screwed on the valve spindle 34. The spring abutment 38 is also provided with a passage in the range of the bore hole 36. The other, outlet side end 40 of the valve spindle 34 is slightly wider. A sealing portion 42 acting as a valve disc is screwed into the head formed in such way. The sealing means cooperates with a sealing 44 arranged in an annular groove in the head 40 of the valve spindle 34.

A sealing 46 in the form of an O-ring is arranged between the pot-shaped spring abutment 38 and the valve spindle 34 tightly fixed thereto. The spring abutment 38 is provided with a deep annular groove 48 which is open in a downstream direction. Two concentric cylindric walls 52 and 54 are defined by the annular groove 48. A helical spring 50 is arranged in the annular groove 48 supported on the spring abutment 38 at the end of the annular groove 48. The spring abutment is sealed against the casing 20 with a sealing 58 and screwed thereto. Atmospheric pressure is present in the space around the spring 50, because it is connected to the outside of the casing by an opening 51.

The spring 50 is effective on the valve seat assembly. This is movably guided on the casing fixed valve spindle 34. The valve seat assembly comprises a shiftable sleeve 60 and a valve seat body 62 screwed thereon. The valve seat body 62 is pot-shaped and cooperates with the valve disc 42 to form a control valve. A sealing 64 is provided between the valve seat body 62 and the shiftable sleeve 60.

The shiftable sleeve 60 is essentially tube-shaped. It is guided on the valve spindle 34 with its upstream portion and sealed against it with a sealing 66. The inner diameter of the shiftable sleeve 60 increases in the range of the head of the valve spindle 34. Thereby a hollow space 68 is formed between the valve spindle 34 and the shiftable sleeve 60 in the range before the valve. The helical spring 50 pushes against the shiftable sleeve.

On its outside the shiftable sleeve is provided with an annular groove with a sealing 70 therein to seal the shiftable sleeve against the casing 20.

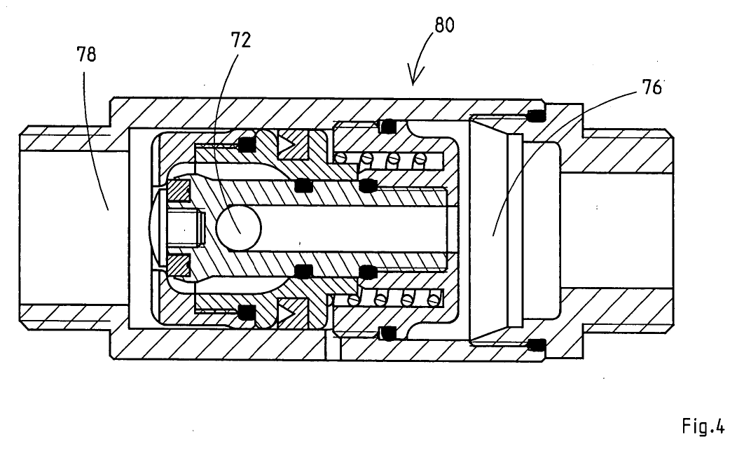

In the range of the head the valve spindle 34 is provided with a radially extending transversal bore hole 72. It can also be seen in FIG. 4 showing a different embodiment, in another cross section. The space before the valve is connected to the inlet chamber 26 through this transversal bore hole 72 and the passage 36.

The pressure reducer operates as follows:

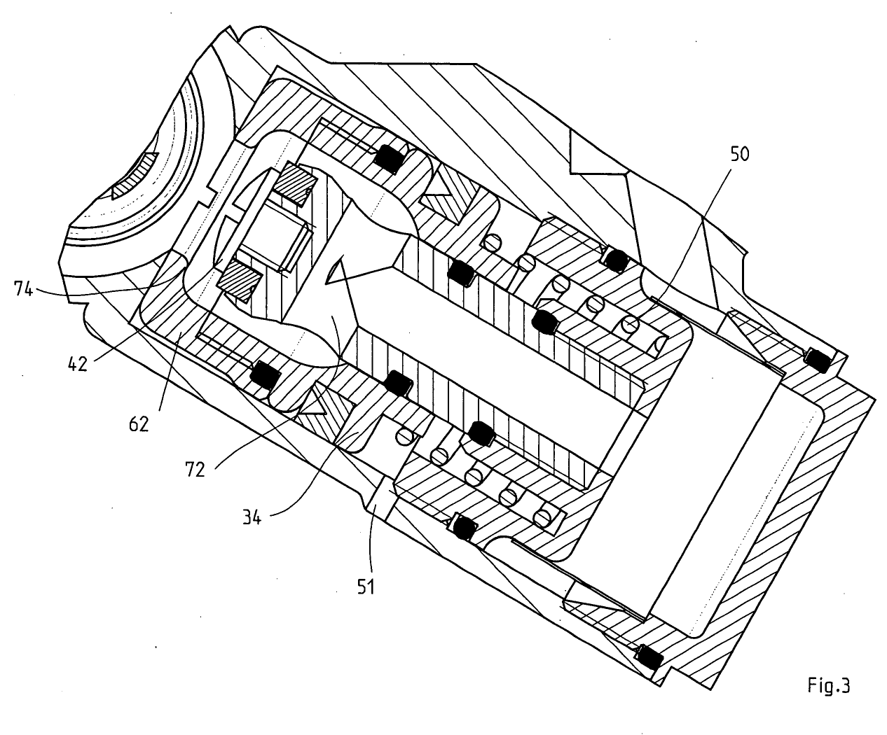

The outlet pressure in the outlet is effective on the annular outer surface of the valve seat body 62 against the power of the helical spring 50. Thereby the valve seat assembly is pushed towards the upper left in FIG. 2 from the valve seat body 62 and the shiftable sleeve 60. The annular gap of the control valve between the fixed valve disc 42 and the valve seat 74 of the valve seat body 62 is reduced. If the outlet pressure in the outlet drops the forces on the valve seat body 62 will be smaller. The force of the helical spring 50 overcomes the outlet pressure and moves the valve seat assembly towards the upper left in FIG. 1, i.e., away from the fixed valve disc 42. Thereby the annular gap is increased so that the outlet pressure can increase again. This situation is shown in FIG. 3. The outlet pressure effective on the valve disc is absorbed by the valve spindle 34 and thereby by the casing.

The embodiment shown in FIGS. 1 to 3 is an embodiment, where the entire pressure reducer assembly is installed with an angle into the fitting. Thereby the assembly is accessible through the lid 32 at all times. However, with suitable diameters the fitting may well be directly installed into a pipe. This is shown in FIG. 4.

As the inlet and the outlet 78 are provided at the respective ends of the pressure reducer assembly 80 a linear assembly is achieved without having side passages.

Whereas the invention is here illustrated and described with reference to embodiments thereof presently contemplated as the best mode of carrying out the invention in actual practice, it is to be understood that various changes may be made in adapting the invention to different embodiments without departing from the broader inventive concepts disclosed herein and comprehended by the claims that follow.

1. A pressure reducer assembly (10) comprising:
an inlet (26), an outlet (78) with an outlet pressure therein, and a valve connecting said inlet (26) to said outlet (78),
said valve having a fixed valve disc (42) and a valve seat body (62) said valve seat body cooperating with said valve disc (42),
said valve seat body having a lifting member (62) which is movable in a closing and in an opening direction thereby closing and opening said valve,
a helical spring (50) biasing said lifting member, said lifting member being exposed to said outlet pressure in said closing direction against said bias of said helical spring (50), and wherein
a space (68) is provided upstream of said valve seat (74),
a valve spindle (34) is provided, said valve spindle (34) being connected to said valve disc (42) and having an axial bore hole (36), and wherein said inlet and said space (68) are in fluid communication through said axial bore hole (36),
said valve seat body (62) is pot shaped and moveably guided on said valve spindle (34), and
said helical spring (50) surrounds said valve spindle (34) coaxially to said bore hole (36) and a spring abutment (38) is provided at said valve spindle (34) and said pot shaped valve seat body (62), said helical spring (50) being supported on said spring abutment (38).

2. A pressure reducer assembly as claimed in claim 1, wherein the assembly is adapted to be inserted in one piece into a tube shaped casing (20) like a cartridge.

3. Pressure reducer assembly as claimed in claim 1, wherein said spring abutment (38) is pot-shaped and provided downstream with an annular groove (48) for positioning said helical spring (50) therein.

4. Pressure reducer assembly as claimed in claim 1, wherein a cylindric dirt trap (28) is provided in said inlet.

5. Pressure reducer assembly as claimed in claim 1, wherein said valve disc (42) is arranged at an outlet side end of said valve spindle (34) and said bore hole in said valve spindle is connected to a hollow space (68) upstream of said valve seat (74) through a radial extending passage (72).
